(19) United States
(12) Patent Application Publication
(10) Pub. No.: US 2026/0177015 A1
(43) Pub. Date: Jun. 25, 2026

(54) FUEL PRESSURE MEASUREMENT AND RELATED PROCESSES, SYSTEMS, AND CONTROLS

(71) Applicant: Cummins-Scania HPCR System, LLC, Columbus, IN (US)

(72) Inventors: Marcus Emanuel Holmgren, Columbus, IN (US); David L. Baldwin, Columbus, IN (US); Xiaoyu Xie, Columbus, IN (US)

(21) Appl. No.: 19/404,734

(22) Filed: Dec. 1, 2025

Related U.S. Application Data
(60) Provisional application No. 63/736,081, filed on Dec. 19, 2024.

(51) Int. Cl. F02D 41/38; F02D 41/22; F02M 59/36; F02M 63/02

(52) U.S. Cl. CPC F02D 41/3845; F02D 41/22; F02M 59/365; F02M 63/0225; F02D 2041/224; F02D 2200/0602

(57) ABSTRACT

A system and process of operating an internal combustion engine system includes a fuel injector in fluid communication with a fuel rail operable to inject fuel during an engine cycle. A high pressure pump is connected to the fuel rail and includes pumping elements that pressurize the fuel and discrete quantity inlet metering valves that control the fuel flow from the pumping elements. Fuel flow from the pumping elements of the high pressure pump to the fuel rail is terminated by the discrete quantity inlet metering valves during a portion of the engine cycle in order to obtain fuel pressure measurements of the fuel rail while fuel is being injected.

### CROSS-REFERENCE TO RELATED APPLICATION

The present application claims priority to, and the benefit of the filing date of, U.S. Provisional Application Ser. No. 63/736,081 filed on Dec. 19, 2024, which is incorporated herein by reference.

### TECHNICAL FIELD

The present application relates to fueling systems for internal combustion engines and related processes, systems, and controls for measuring fuel pressure and implementing fuel pressure measurements.

### BACKGROUND

Fueling systems for internal combustion engines and controls for such systems employ pressure measurements of the fuel system for injection quantity determinations, injector control, diagnostics, and other purposes. Existing techniques for obtaining fuel pressure measurements suffer from a number of shortcomings including those respecting rapidity, intrusiveness, complexity, precision, reliability, and robustness, among other shortcomings. There remains a significant need for the unique processes, systems, and controls disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY

Some embodiments comprise a unique process for rapidly and non-intrusively obtaining fuel system pressure measurements while operating an internal combustion engine. Some embodiments comprise unique systems for internal combustion engines that include fuel injection systems and a controller for rapidly and non-intrusively obtaining pressure measurements in a fuel system of the internal combustion engine. Some embodiments comprise unique apparatuses for obtaining rapid and non-intrusive measurements of fuel pressure for internal combustion engines.

An aspect of the present disclosure is directed to a new control strategy for a high pressure fuel pump. In an embodiment, micro-cutouts of fuel pump events by the fuel pump are employed on every engine cycle to measure fuel pressure, which creates a non-intrusive system and method for controlling fueling. By removing the pumping event from a single injection event per engine cycle (with some throttling), this disclosed strategy enables precise fueling measurements without the need for intrusive pump-cutout requests. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of a system including an internal combustion engine, an example fueling system, and an example electronic control system for obtaining measurements of fuel pressure in the fuel system.

FIG. 2 is a schematic diagram illustrating certain aspects of the example fuel system of FIG. 1.

FIG. 3 is a schematic diagram illustrating certain additional aspects of an example of the fuel system of FIGS. 1 and 2.

FIG. 4 is a flow diagram of an example process for obtaining fuel system pressure measurements with the system of FIG. 1 and fuel systems of FIGS. 2 and 3.

FIG. 5 is a graph showing exemplary rail pressures without pump cutout and with pump cutout during an engine cycle according to the process of FIG. 4.

FIG. 6A is a graph showing exemplary rail pressure and current over time during fuel pressure measurement when discrete quantity inlet metering valves (also known as active inlet metering valves or AIM valves) are used to control fuel flow to each pumping element according to the process of FIG. 4.

FIG. 6B shows a comparison to FIG. 6A of exemplary rail pressures and current over time for a process that uses a single variable flow inlet metering valve (also known as single adjustable orifice inlet metering valve) that controls fuel flow to multiple pumping elements.

FIG. 7 is a flow diagram of an example process for determining fuel quantity using fuel system pressure measurements obtained according to the process of FIG. 4.

### DETAILED DESCRIPTION OF EXAMPLE EMBODIMENTS

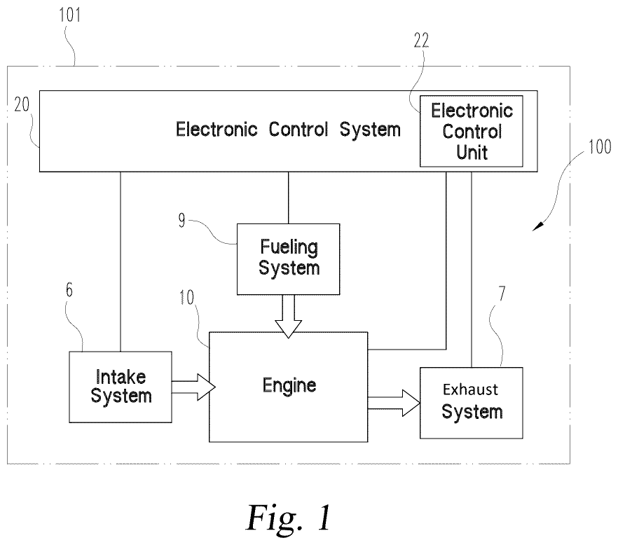

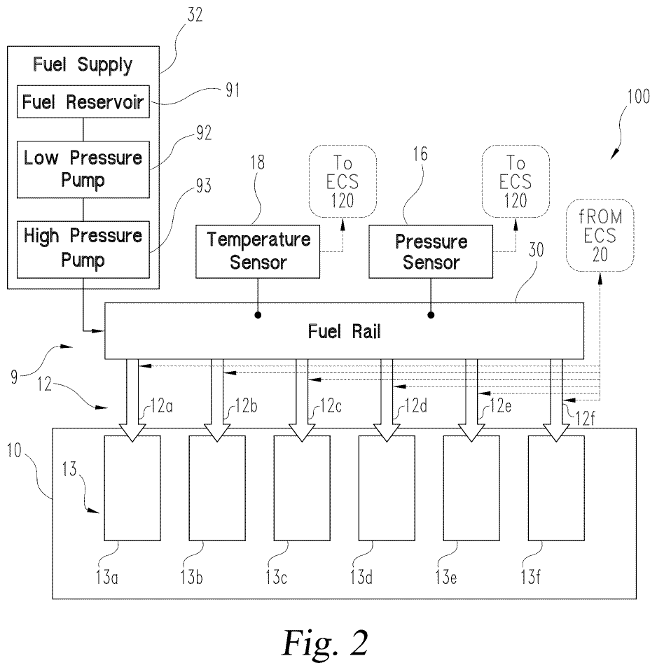

With reference to FIGS. 1 and 2, there is illustrated an example engine system 100 (also referred to as system 100) comprising an engine 10 operatively coupled with an intake system 6, an exhaust system 7, and a fueling system 9. The engine 10 may be an internal combustion engine, including but not limited to a compression-ignition engine, using diesel or other suitable fuel, or a spark-ignition engine, using gasoline, natural gas, hydrogen, or other suitable fuels. Engine 10 receives intake air from intake system 6 and fuel from fueling system 9, combusts these inputs and outputs exhaust via exhaust system 7.

Engine 10 comprises a plurality of combustion cylinders 13 including respective reciprocating pistons (not depicted) configured to generate mechanical power from the combustion of a fuel during a combustion cycle. In the illustrated example, engine 10 is configured as a six-cylinder engine that includes combustion cylinders 13a, 13b, 13c, 13d, 13e, 13f. In other embodiments, engine 10 may be configured and provided with a different number of cylinders, for example, four cylinders, eight cylinders, twelve cylinders, sixteen cylinders, or other numbers of cylinders as will occur to one of skill in the art with the benefit and insight of the present disclosure.

Engine 10 comprises a plurality of fuel injectors 12 configured to provide fuel to respective combustion cylinders 13. In the illustrated example, engine 10 comprises six injectors 12a, 12b, 12c, 12d, 12e, 12f in fluid communication and configured and operable to inject fuel into combustion cylinders 13a, 13b, 13c, 13d, 13e, 13f, respectively. It shall be appreciated that the number of fuel injectors provided in other embodiments may vary in correspondence to the number of cylinders, or may vary per-cylinder, for example, with multiple injectors being provided per-cylinder.

Each cylinder 13a, 13b, 13c, 13d, 13e, 13f operates according to a combustion cycle in which fuel is injected for combustion. For a four-stroke engine, the combustion cycle includes an intake stroke, a compression stroke, a power stroke, and an exhaust stroke for the piston in the corresponding cylinder 13a, 13b, 13c, 13d, 13e, 13f (individually and collectively referred to herein as cylinder(s) 13.) The four strokes of the piston correspond to two complete revolutions of the crankshaft connected to the pistons, or 720 degrees, during which fuel may or may not be injected by fuel injectors 12a, 12b, 12c, 12d, 12e, 12f (individually and collectively referred to herein as fuel injector(s) 12). However, the present disclosure contemplates application with other combustion cycles, such as those employing two strokes of the piston for each combustion cycle. As used herein, an engine cycle is the amount of rotation required from the engine crankshaft to complete the combustion cycle of one cylinder, such as 720 degrees for a four stroke engine or 360 degrees for a two stroke engine.

In the illustrated embodiment, fueling system 9 is configured and provided as a high-pressure common-rail fuel injection system including a fuel rail 30 configured and operable to supply fuel at a relatively high pressure to the plurality of fuel injectors 12. A fuel supply 32 is configured and operable to supply fuel to fuel rail 30 and may include a fuel reservoir 91, a low-pressure pump 92 operatively coupled with the fuel reservoir 91, and a high-pressure pump 93 operatively coupled with the low pressure pump 92 and the fuel rail 30. High-pressure fuel lines (not numbered) fluidically couple high pressure pump 93 with fuel rail 30, and fuel rail 30 with the plurality of injectors 12.

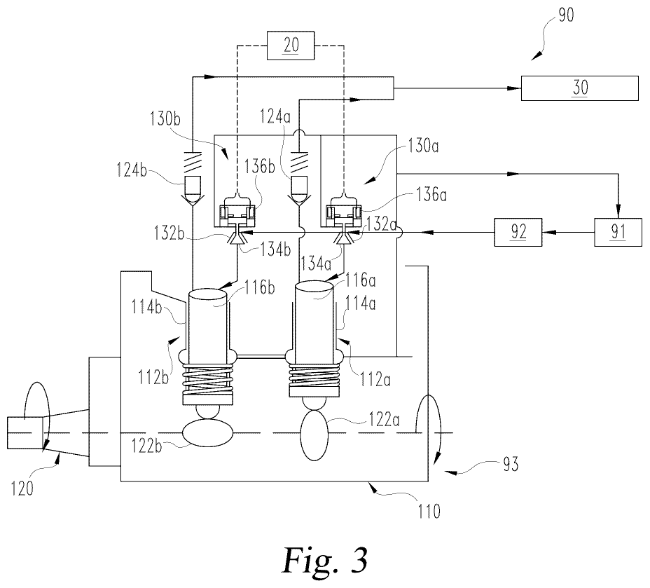

With further reference to FIG. 3, further aspects of an embodiment of fueling system 9 are shown. High pressure pump 93 includes a pump housing 110 that contains a pump camshaft 120 coupled to the engine crankshaft for rotation in a known timing therewith. Pump housing 110 also includes a number of pumping elements 112a, 112b each having an inlet and an outlet. Pumping elements 112a, 112b may each include, for example, a fluid chamber 114a, 114b and a piston 116a, 116b housed in the corresponding fluid chamber 114a 114b. Pistons 116a, 116b are connected to camshaft 120 so that rotation of the camshaft 120 by the engine crankshaft rotates cam lobes 122a, 122b, which act on the connected piston 116a, 116b to reciprocate the connected piston 116a, 116b and provide pressurized fuel to fuel rail 30 through the corresponding outlet of pumping element 112a, 112b. Each of the outlets from pumping elements 112a, 112b may include a check valve 124a, 124b to prevent reverse flow into fluid chambers 114a, 114b and that open when discrete quantity inlet metering valves 130a, 130b are controlled to provide fuel to fuel rail 30.

Fuel flow to and from the pumping elements 112a, 112b is controlled by a corresponding discrete quantity inlet metering valve 130a, 130b mounted on or near housing 110. Each discrete quantity inlet metering valve 130a, 130b includes an inlet that receives fuel from low pressure pump 92 and an outlet connected to the corresponding pumping element 112a, 112b. Each discrete quantity inlet metering valve 130a, 130b includes a check valve provided by a valve seat 132a, 132b, a plunger 134a, 134b, and an actuator 136a, 136b such as a solenoid, respectively. Plunger 134a, 134b is movable by an electric current supplied to actuator 136a, 136b from a first position disengaged from the corresponding valve seat 132a, 132b to a second position that is engaged to the corresponding valve seat 132a, 132b. It is contemplated herein that discrete quantity inlet metering valves 130a, 130b can be normally open to a first position as shown, or normally closed inlet metering valves in other embodiments.

In the first position of each discrete quantity inlet metering valve 130a, 130b, such as when the current is not supplied to actuators 136a, 136b, fuel flow from the connected pumping element 112a, 112b is cutout or terminated such that actuation of the pumping element 112a, 112b forces fuel from the fluid chambers 114a, 114b back to the low pressure side and not to fuel rail 30. In the second position of discrete quantity inlet metering valve 130a, 130b, fuel in the connected fluid chamber 114a, 114b is pumped by the pumping elements 112a, 112b to fuel rail 30. Discrete quantity inlet metering valves 130a, 130b also include bleed lines for bleeding air to return to fuel reservoir 91. Pumping elements 112a, 112b may also be connected to the return line to return any leaked or bled fuel to fuel reservoir 91.

System 100 further includes an electronic control system (ECS) 20 in communication with engine 10 and configured to control one or more aspects of engine 10, including controlling the injection of fuel into engine 10 via fuel injectors 12 and the flow of fuel into pumping elements 112a, 112b via discrete quantity inlet metering valves 130a, 130b. Accordingly, ECS 20 is in communication with the discrete quantity inlet metering valves 130a, 130b and configured to command each discrete quantity inlet metering valve 130a, 130b on and off at prescribed times relative to an angular position of camshaft 120 during each engine cycle to pump fuel into fuel rail 30 to regulate injection pressure as desired for injection of fuel into the engine 10. ECS 20 may also be in communication with fuel injectors 12 and configured to command each fuel injector 12 on and off at prescribed times to inject fuel into the engine 10 as desired. ECS 20 includes at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12 and actuators 136a, 136b of discrete quantity inlet metering valves 130a, 130b. The sensors may include any suitable devices to monitor operating parameters and functions of the system 100. For example, the sensors may include a pressure sensor 16 and a temperature sensor 18. Pressure sensor 16 is in communication with the common fuel rail 30 and structured to communicate a measurement of the pressure within the common fuel rail 30 to ECS 20. Temperature sensor 18 is in communication with common fuel rail 30 and structured to communicate a measurement of the temperature within common fuel rail 30 to ECS 20.

As will be appreciated by the description that follows, the techniques described herein relating to fuel injector or fuel injection parameters can be implemented in ECS 20, which may include one or more controllers for controlling different aspects of system 100. In one form ECS 20 comprises one or more electronic control units (ECU) 22 such as an engine control unit or engine control module. ECS 20 may be comprised of digital circuitry, analog circuitry, or a hybrid combination of both of these types. Also, ECS 20 may be programmable, an integrated state machine, or a hybrid combination thereof. ECS 20 may include one or more Arithmetic Logic Units (ALUs), Central Processing Units (CPUs), memories, limiters, conditioners, filters, format converters, or the like which are not shown to preserve clarity. In one form, ECS 20 is of a programmable variety that executes algorithms and processes data in accordance with operating logic that is defined by programming instructions (such as software or firmware). Alternatively or additionally, operating logic for ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of engine system 100. As used herein, the term sensors may include any suitable hardware and/or software used to sense or estimate any engine system parameter and/or various combinations of such parameters either directly or indirectly.

Engine system 100 may be provided and implemented in connection with equipment 101 which may comprise, for example, a vehicle, such as an on-highway vehicle, an off-highway vehicle, a marine vehicle, or other type of vehicle, a generator set, a pumping set, or various other equipment as will occur to one of skill in the art with the benefit and insight of the present disclosure.

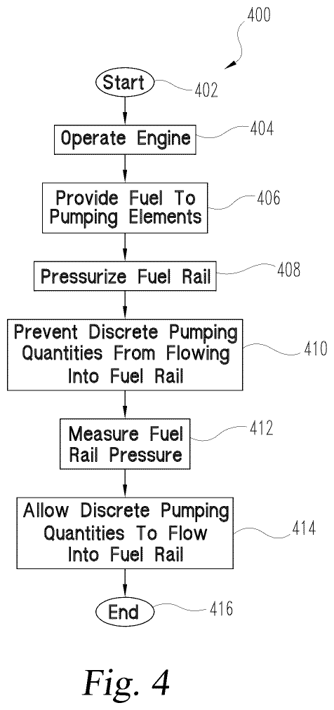

With reference to FIG. 4, there is illustrated a flow diagram illustrating certain aspects of an example process 400 which may be implemented in and executed by one or more components of an electronic control system, such as ECS 20, for example. In some forms, at least a portion of process 400 may be implemented in one or more electronic control units of an electronic control system such as ECU 22 or additional or alternative electronic control units.

Process 400 begins at start operation 402 such as in response to a key-on event or engine start, and proceeds to operation 404 at which an engine system such as engine system 100 or another suitable engine system is operated. In the illustrated example, engine system 100 is operated in-mission during process 400, meaning that it operates according to the needs of a particular mission or application without requiring entry into a diagnostic or test mode (e.g., engine motoring), test cell, or otherwise disrupting normal mission operation. It shall be appreciated that other embodiments may additionally or alternatively operate an engine system ex-mission, such as in a test mode, test cell, or other out of mission operation.

From operation 404, process 400 proceeds to operation 406 in which fuel is provided to pumping elements 112a, 112b of high pressure pump 93 through each of the corresponding discrete quantity inlet metering valves 130a, 130b. Process 400 continues at operation 408 to pressurize fuel rail 30 with the fuel. As discussed above, fuel rail 30 is connected to fuel injectors 12, which are operable to inject fuel into corresponding ones of the cylinders 13 of engine 10 during a combustion cycle of the corresponding cylinder 13. It should be understood that operations 406, 408 can all occur simultaneously and/or in different order than as illustrated.

Process 400 continues from operation 408 at operation 410 to control each of the plurality of discrete quantity inlet metering valves 130a, 130b to terminate or prevent discrete pumping quantities from each of the corresponding pumping elements 112a, 112b to fuel rail 30 during an engine cycle associated with the crankshaft of engine 10. For example, a control signal from ECS 20 and/or ECU 22 can control actuators 136a, 136b to allow or cause plungers 134a, 134b to remain disengaged from the corresponding valve seat 132a, 132b to terminate or cutout the fuel flow to fuel rail 30 for a fuel injection event during the engine cycle. This pump cutout (PCO) occurs in a manner that is timed at a predetermined angular position of camshaft 120 depending on the fueling timing of the fuel injector 12 being measured. The fuel in the corresponding fluid chamber 114a, 114b is pumped out while the discrete quantity inlet metering valve 130a, 130b is controlled to terminate the fuel flow from pumping chambers 114a, 114b to fuel rail 30 and the fuel in pumping chambers 114a, 114b is pumped back to the low pressure side of pumping elements 112a, 112b.

From operation 410, process 400 continues at operation 412 to measure the fuel rail pressure in fuel rail 30 while the discrete quantity inlet metering valves 130a, 130b are controlled to terminate the fuel flow to fuel rail 30 during the injection event. Since discrete quantity inlet metering valves 130a, 130b are controlled to terminate the fuel flow for the injection event for a period of time during the engine cycle defined by a pump cutout window, the fuel flow from pumping chambers 114a, 114b is terminated during the engine cycle during the pump cutout window. Operation 412 occurs while one or more of the injectors 12 injects fuel from fuel rail 30 into the corresponding combustion cylinder 13. Operation 412 may, for example, process outputs of a high data rate pressure sensor such as pressure sensor 16 or another pressure sensor configured to provide output indicative of a fuel pressure of fuel rail 30. Such processing may include, for example, filtering, sampling, and/or other processing techniques as will occur to one of skill in the art with the benefit and insight of the present disclosure.

Process 400 then continues at operation 414 to control the discrete quantity inlet metering valves 130a, 130b so that discrete pumping quantities of fuel flow are allowed to flow to fuel rail 30 from pumping elements 112a, 112b in the same engine cycle in which the pressure measurements of fuel rail 30 were made during the pump cutout. Operations 410, 412, and 414 may then be repeated provided enablement conditions are met in the following engine cycles of engine 10 to take additional pressure measurements at the same or different crank angle start position and/or for a same or different crank angle duration. Process 400 ends at operation 416, such as in response to a key off event, engine stop event, or other process terminating event.

The pressure measurements of fuel rail 30 obtained from process 400 may be used in controlling the operation of engine 10 and/or fueling system 9, and/or in diagnosing engine 10 and/or fueling system 9. For example, the pressure measurements can be used to model the dynamic rail pressure of fuel rail 30, which can then be used to determine actual injection quantities and control a fuel injection control parameter, such as an injection quantity (e.g., a total injection quantity for set of multiple injector pulses, a distribution of a quantity among multiple injection pulses, or an injection quantity for a given injector pulse), a rail pressure, an injection timing (e.g., a start of injection for a set of multiple injector pulses, a spacing or separation between multiple injector pulses, or a start of injection of a given injector pulse), and/or other injection control parameters as will occur to one of skill in the art with the benefit and insight of the present disclosure. The pressure measurements may also be used in other control operations, such as in determining fuel properties, fuel system health, system leakage, and/or to infer sonic speed.

It shall be appreciated that multiple iterations of process 400 and/or operations 410, 412, 414 may be performed in connection with a given set of rail pressure measurements. It shall be further appreciated operation 412 may be performed during multiple pulses of one or more injectors 12, for example, for multiple pulses of a fuel injector 12 per engine cycle or for multiple injections from multiple injectors 12 during multiple engine cycles.

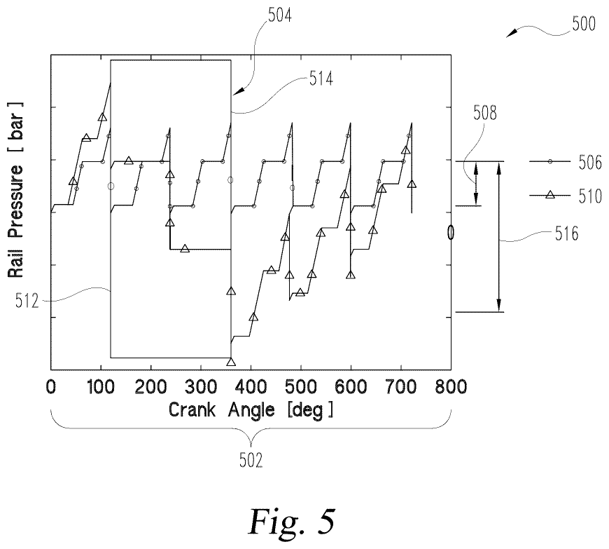

For example, FIG. 5 shows a graph 500 with rail pressures with and without a pump cutout during an engine cycle 502 along with an exemplary pump cutout window 504 during the engine cycle 502. The nominal rail pressure 506 is the fuel pressure in fuel rail 30 that occurs during fuel injection from the fuel injectors 12 over the engine cycle without a pump cutout. The nominal rail pressure 506 is maintained within a nominal pressure drop band 508 throughout the engine cycle 502.

A pump cutout rail pressure 510 shows the fuel pressure in common rail 30 that occurs during a pressure measurement process, such as process 400, when there is a pump cutout during the engine cycle. When fuel flow from pumping elements 112a, 112b to fuel rail 30 is cutout or terminated by discrete quantity inlet metering valve 130a, 130b at start time 512, fuel is no longer provided to fuel rail 30 so the pressure in fuel rail 30 drops in the window 504 until end time 514. The pressure measurements of fuel rail 30 are made within pump cutout window 504 while the discrete quantity inlet metering valves 130a, 130b are controlled to terminate the fuel flow. At end time 514, discrete quantity inlet metering valves 130a, 130b are controlled to re-establish fuel flow and the rail pressure begins to increase and can recover to nominal rail pressure conditions by the end of the engine cycle 502.

Pump cutout rail pressure 510 defines a larger pressure drop band 516 than the nominal pressure drop band 508 due to the pressure in fuel rail 30 dropping while fuel flow is terminated during the pump cutout window 504. However, since each individual pumping event on high pressure fuel pump 93 is controlled by the discrete quantity inlet metering valves 130a, 130b, pump cutout window 504 can be relatively small in duration and contained within one engine cycle to allow non-intrusive pressure measurements to occur while fuel is being injected into the cylinders 13 by injectors 12. In addition, a relatively small spacing between successive pressure measurements from one engine cycle to the next can occur since it has negligible impact on combustion and emissions to obtain the pressure measurements.

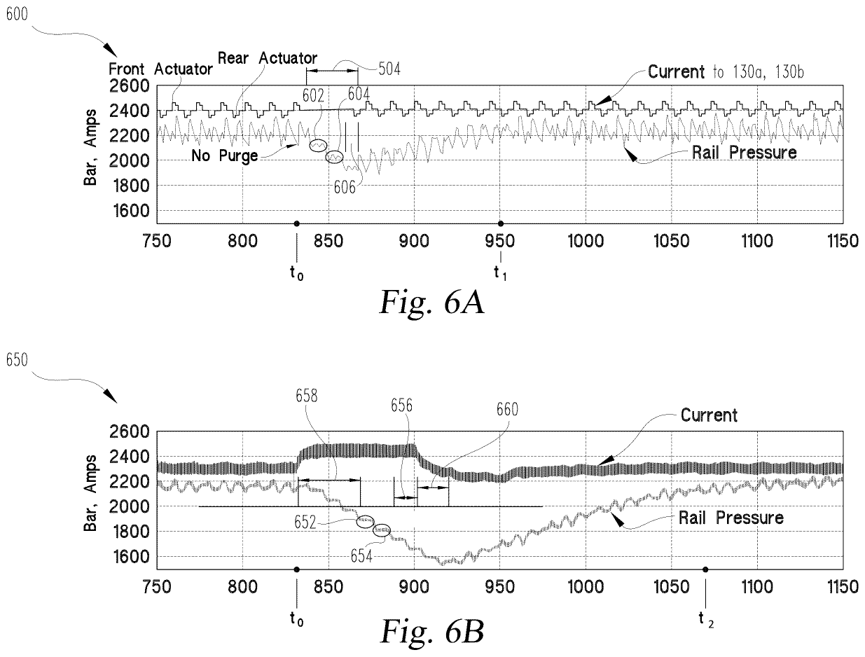

With reference to FIG. 6A, graph 600 illustrates rail pressure and electrical current over time during an exemplary engine cycle in which discrete quantity inlet metering valves 130a, 130b are controlled via the electrical current to cutout fuel flow from pumping elements 112a, 112b to fuel rail 30. The current flow to discrete quantity inlet metering valves 130a, 130b is terminated at time to, which corresponds to start time 512 of pump cutout window 504, so that the discrete quantity inlet metering valves 130a, 130b terminates the fuel flow from pumping elements 112a, 112b to fuel rail 30. Since there is no need to purge pumping elements 112a, 112b, pressure measurements 602, 604 can occur immediately at time to with no delay for purging.

In the illustrated example, two pressure measurements 602, 604 are taken within the pump cutout window 504, and then the end 514 of pump cutout window 504 occurs and discrete quantity inlet metering valves 130a, 130b are controlled to allow fuel flow to fuel rail 30. There is a small delay 606 for controls and pump latency, after which the rail pressure increases back to nominal rail pressure conditions at time t₁. The intrusion into the nominal operating pressures for the fuel rail pressure measurements using process 400 thus extends from time t₀ to time t₁.

FIG. 6B illustrates a graph 650 with rail pressure and electrical current over time during an exemplary engine cycle in which a single adjustable orifice inlet metering valve is used to control the fuel flow to all the pumping elements of the high pressure fuel pump. The current flow to the single inlet metering valve is terminated at time to, similar to graph 600. However, before pressure measurements 652, 654 can be taken, a closing and purge time 658 is required since the single inlet metering valve must be energized long enough to fully shut off flow to the pump and so that pumping elements of the high pressure pump are then allowed to purge any remaining fuel to allow pressure measurements. When the pressure measurements are complete, a delay 660 for the opening of the single inlet metering valve is required in addition to the controls latency 656.

Thus, the intrusion for the fuel rail pressure measurements when a single inlet metering valve controls fuel flow to all the pumping elements extends from time t₀ to time t₂. This intrusion is substantially greater than the intrusion required using process 400 of the present disclosure, as shown in graph 600. In an example, the intrusion of the prior process shown by graph 650 may be more than two times as long as the intrusion of process 400 in taking pressure measurements. In addition, the rail pressure drop using the process 400 in FIG. 6A is less than the pressure drop that occurs in FIG. 6B.

The reduced intrusion provided by process 400 of the present disclosure allows faster convergence of adaption algorithms that use the pressure measurement data, and enables the use of algorithms that leverage rapid pressure measurements to improve fueling accuracy and potentially improve fuel economy by enabling smaller injections. The reduced intrusion allows more frequent measurement, which enables faster convergence of adaption algorithms.

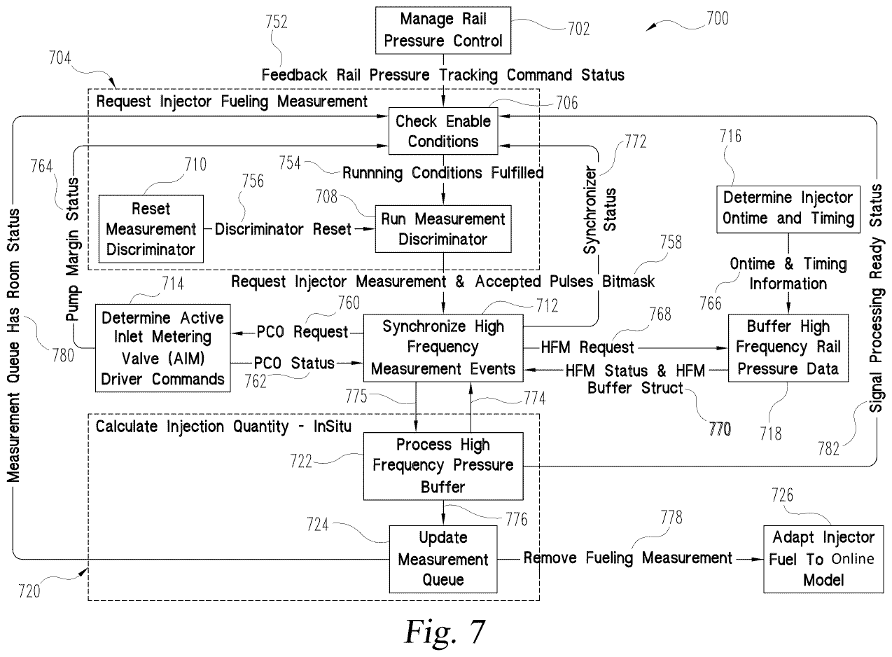

With reference to FIG. 7, there is illustrated a flow diagram illustrating an example process 700 for determining fueling quantities that employs, for example, process 400 to obtain pressure measurements of fuel rail 30. Process 700 begins at manage rail pressure control block 702 which initiates the process for estimating fueling quantities. Manage rail pressure control block 702 outputs a signal 752 for feedback rail pressure tracking command status to a sub-process 704. Sub-process 704 provides a routine to initiate a request for injector fueling quantity measurement.

Sub-process 704 includes a check enable conditions block 706 that checks enable conditions to establish whether conditions for running the process 700 are fulfilled. Any suitable enable conditions are contemplated for running process 700. Examples of enable conditions include engine temperature threshold, operating point (fueling and pressure command) stability, fuel pressure control margin, and signal processing capacity. The check enable conditions block 706 outputs a running condition signal 754 when the enable conditions are fulfilled to a run measurement discriminator block 708. Sub-process 704 also includes a reset measurement discriminator block 710 that resets the measurement discriminator when ECU 22 first powers up or when the maintenance time has reached a calibrated threshold.

Reset measurement discriminator block 710 outputs a discriminator reset signal 756 that forces the run measurement discriminator block 708 to initialize the memory of the measurement discriminator. Run measurement discriminator block 708 outputs a combined signal 758 to request injector measurement and accepted pulses bitmask to synchronize high frequency pressure measurement events (synchronizer) block 712. The two outputs of combined signal 758 from the run measurement discriminator block 708 are the injector number for the requested fueling measurement and a bitmask. The bitmask identifies which pulses in the packet are dispersed enough to use in the pressure measurement. If one or more pulses is accepted the synchronizer activates.

Process 700 further includes the synchronizer block 712 outputting a pump cutout (PCO) request signal 760 to a block 714 that determines the discrete quantity inlet metering valve drive commands for discrete quantity inlet metering valves 130a, 130b. Block 714 outputs a PCO start information signal 762 to synchronizer block 712 that informs that the pump cutout is available in the current engine cycle. If enable conditions are satisfied, synchronizer block 712 will ask block 714 repeatedly during the engine cycle until the pump cutout window can be accommodated. Block 714 also outputs a pump mass delivery margin status 764 to check enable conditions block 704. The pump mass delivery margin is herein calculated to ensure that pressure control is restored to its nominal value within one engine cycle of the pump cutout.

Process 700 also includes a determine injector on-time and timing block 716. Determine injector on-time and timing block 716 outputs an injector on-time and timing signal 766 to a buffer high frequency rail pressure data block 718. Buffer high frequency rail pressure data block 718 also receives a high frequency measurement request signal 768 from synchronizer block 712 once synchronizer block 712 is informed if the pump cutout will occur in the present engine cycle or next engine cycle. High frequency measurement request signal 768 informs the buffer high frequency rail pressure data block 718 that a pressure measurement is upcoming. Buffer high frequency rail pressure data block 718 outputs a high frequency measurement request and a high frequency measurement buffer structure signal 770 to synchronizer block 712. Signal 770 informs the synchronizer block 712 of the high frequency measurement status and, when the status transitions from active to complete, the high frequency measurement buffer structure is sent to synchronizer block 712 with the coherent on-time and timing information for the injectors. Synchronizer block 712 also outputs a synchronizer status signal 772 to check enable conditions block 706 to indicate when the synchronizer is active and when the synchronizer update is complete. Synchronizer block 712 readies a coherent injection measurement packet for processing in a window established at a high frequency pressure buffer processing block 722 via a first signal 774 when a pump cutout at block 714 can be accommodated in the current engine cycle.

Coherent injection measurement packet signal 775 is then provided from synchronizer block 712 to buffer processing block 722 of sub-process 720. The synchronizer block 712 appends the accepted pulses bitmask and injector number to the high frequency measurement buffer structure, which now contains the pressure buffer, on-time, timing, injector number, and the accepted pulses bitmask.

When block 722 is finished processing the packet, it outputs a fueling estimate associated with the commanded on-time and measured rail pressure, which is provided as an add fueling measurement signal 776 to update measurement queue block 724. Add fueling measurement signal 776 sends the estimated fueling to the measurement queue. In addition, block 722 provides a signal processing ready status signal to enable conditions block 706 to indicate when block 722 is busy processing the data and when block 722 is finished processing the data and is ready for additional processing.

Measurement queue block 724 provides a remove fueling measurement signal 778 to an adapt injector fuel to online model block 726 so that the online model takes one measurement from the queue block 724 to use in determining the fuel injection quantity. Update measurement queue block 724 also outputs a measurement queue room status signal 780 to enable conditions block 706 whenever measurements are added to and removed from queue block 724.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

As illustrated by this detailed description the present disclosure contemplates a number of aspects and embodiments including the following non-limiting examples. According to one aspect of the disclosure, a process of operating an internal combustion engine system is provided. The process includes providing fuel to a plurality of pumping elements through a plurality of discrete quantity inlet metering valves associated with corresponding ones of the plurality of pumping elements; pressurizing a fuel rail with fuel output from the plurality of pumping elements, the fuel rail connected to a plurality of fuel injectors that are operable to inject fuel into corresponding ones of a plurality of cylinders of an internal combustion engine during an engine cycle of the corresponding one of the plurality of cylinders; controlling each of the plurality of discrete quantity inlet metering valves to terminate a fuel flow from each of the plurality of pumping elements to the fuel rail during the engine cycle; measuring a pressure of the fuel rail while the fuel flow from the plurality of pumping elements is terminated during the engine cycle; and controlling the plurality of discrete quantity inlet metering valves to provide fuel flow from at least one of the plurality of pumping elements to the fuel rail during the engine cycle after measuring the pressure of the fuel rail.

In an embodiment, the process includes at least one of controlling and diagnosing the internal combustion engine system in response to the measured pressure of the fuel rail.

In an embodiment, fuel is injected by at least one of the plurality of fuel injectors during the engine cycle while the pressure of the fuel rail is measured.

In an embodiment, fuel is injected by two or more of the plurality of fuel injectors during the engine cycle while the pressure of the fuel rail is measured.

In an embodiment, the plurality of pumping elements includes a first pumping element and a second pumping element. The plurality of discrete quantity inlet metering valves includes a first discrete quantity inlet metering valve upstream of the first pumping element and a second discrete quantity inlet metering valve upstream of the second pumping element.

In an embodiment, each of the first pumping element and the second pumping element includes a chamber housing a piston that is reciprocated in the chamber to pump the fuel from the chamber to the fuel rail.

In an embodiment, controlling each of the plurality of discrete quantity inlet metering valves to terminate the fuel flow includes controlling each of the plurality of discrete quantity inlet metering valves at a predetermined angle of a camshaft that drives a pumping element of the corresponding discrete quantity inlet metering valve.

In an embodiment, measuring the pressure of the fuel rail occurs immediately after terminating the fuel flow without purging the pumping elements.

In an embodiment, the process includes controlling each of the plurality of discrete quantity inlet metering valves a second time to terminate the fuel flow from each of the pumping elements to the fuel rail during the engine cycle; measuring the pressure of the fuel rail while the fuel flow to the fuel rail from the plurality of pumping elements is terminated during the second time; and controlling the plurality of discrete quantity inlet metering valves to provide fuel flow to the fuel rail from at least one of the plurality of pumping elements during the second time after measuring the pressure of the fuel rail during the second time.

In an embodiment, measuring the pressure of the fuel rail during the engine cycle includes making at least one pressure measurement of the fuel rail.

Another aspect of the present disclosure is directed to a system that includes an internal combustion engine. Th system includes a fuel injector in fluid communication with a fuel rail, and the fuel injector is operable to provide fuel to a cylinder of the internal combustion engine during an engine cycle. The system includes a high pressure pump in fluid communication with the fuel rail, and the high pressure pump includes a plurality of pumping elements and a plurality of discrete quantity inlet metering valves associated with respective ones of the plurality of pumping elements. The system includes an electronic control system configured to control each of the plurality of discrete quantity inlet metering valves to terminate a fuel flow from the plurality of pumping elements to the fuel rail during the engine cycle; measure a pressure of the fuel rail while the fuel flow from the plurality of pumping elements is terminated during the engine cycle; and controlling the plurality of discrete quantity inlet metering valves to provide fuel flow from at least one of the pumping elements to pressurize the fuel rail during the engine cycle after measuring the pressure of the fuel rail.

In an embodiment, each of the plurality of discrete quantity inlet metering valves includes a valve seat, a plunger positionable to engage and disengage the valve seat, and a solenoid operable to actuate the plunger to disengage or engage the valve seat to open or close the discrete quantity inlet metering valve so that fuel flows to the fuel rail.

In an embodiment, each of the plurality discrete quantity inlet metering valves further includes a check valve downstream of the valve seat.

In an embodiment, the plurality of pumping elements includes a first pumping element and a second pumping element. Each of the first pumping element and the second pumping element includes chamber and a piston housed in the chamber to pump fuel from the chamber to the fuel rail. The plurality of discrete quantity inlet metering valves includes a first discrete quantity inlet metering valve upstream of the first pumping element and a second discrete quantity inlet metering valve upstream of the second pumping element.

In an embodiment, the electronic control system is configured to control each of the plurality of discrete quantity inlet metering valves to terminate the fuel flow at a predetermined camshaft angle of a camshaft that drives a pumping element of the corresponding discrete quantity inlet metering valve during the engine cycle.

In an embodiment, the electronic control system is configured to measure the pressure of the fuel rail immediately after the fuel flow is terminated and without purging the pumping elements.

In an embodiment, the electronic control system is configured to control each of the plurality of discrete quantity inlet metering valves a second time to terminate the fuel flow from the pumping elements to the fuel rail during the second time; measure the pressure of the fuel rail while the fuel flow to the fuel rail from the plurality of pumping elements is terminated during the second time; and control the plurality of discrete quantity inlet metering valves to provide fuel flow to the fuel rail from at least one of the plurality of pumping elements during the second time after measuring the pressure of the fuel rail during the second time.

In an embodiment, the electronic control system is configured to inject fuel from the fuel injector during the engine cycle while the pressure of the fuel rail is measured.

In an embodiment, the fuel injector includes a plurality of fuel injectors in fluid communication with the fuel rail, and the electronic control system is configured to inject fuel from at least two of the fuel injectors during the engine cycle while the pressure of the fuel rail is measured.

According to another aspect of the disclosure, a method includes cutting out at least one fuel pump event associated with at least one injection event during each engine cycle of a plurality of engine cycles and measuring a fuel pressure while the fuel pump event is cut-out.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A process of operating an internal combustion engine system, the process comprising:
providing fuel to a plurality of pumping elements through a plurality of discrete quantity inlet metering valves associated with corresponding ones of the plurality of pumping elements;
pressurizing a fuel rail with fuel output from the plurality of pumping elements, the fuel rail connected to a plurality of fuel injectors that are operable to inject fuel into corresponding ones of a plurality of cylinders of an internal combustion engine during an engine cycle of the corresponding one of the plurality of cylinders;
controlling each of the plurality of discrete quantity inlet metering valves to terminate a fuel flow from each of the plurality of pumping elements to the fuel rail during the engine cycle;
measuring a pressure of the fuel rail while the fuel flow from the plurality of pumping elements is terminated during the engine cycle; and
controlling the plurality of discrete quantity inlet metering valves to provide fuel flow from at least one of the plurality of pumping elements to the fuel rail during the engine cycle after measuring the pressure of the fuel rail.

2. The process of claim 1, further comprising:
at least one of controlling and diagnosing the internal combustion engine system in response to the measured pressure of the fuel rail.

3. The process of claim 1, wherein fuel is injected by at least one of the plurality of fuel injectors during the engine cycle while the pressure of the fuel rail is measured.

4. The process of claim 1, wherein fuel is injected by two or more of the plurality of fuel injectors during the engine cycle while the pressure of the fuel rail is measured.

5. The process of claim 1, wherein:
the plurality of pumping elements includes a first pumping element and a second pumping element; and
the plurality of discrete quantity inlet metering valves includes a first discrete quantity inlet metering valve upstream of the first pumping element and a second discrete quantity inlet metering valve upstream of the second pumping element.

6. The process of claim 5, wherein each of the first pumping element and the second pumping element includes a chamber housing a piston that is reciprocated in the chamber to pump the fuel from the chamber to the fuel rail.

7. The process of claim 1, wherein controlling each of the plurality of discrete quantity inlet metering valves to terminate the fuel flow includes controlling each of the plurality of discrete quantity inlet metering valves at a predetermined angle of a camshaft that drives a pumping element of the corresponding discrete quantity inlet metering valve.

8. The process of claim 1, wherein measuring the pressure of the fuel rail occurs immediately after terminating the fuel flow without purging the pumping elements.

9. The process of claim 1, further comprising:
controlling each of the plurality of discrete quantity inlet metering valves a second time to terminate the fuel flow from each of the pumping elements to the fuel rail during the engine cycle;
measuring the pressure of the fuel rail while the fuel flow to the fuel rail from the plurality of pumping elements is terminated during the second time; and
controlling the plurality of discrete quantity inlet metering valves to provide fuel flow to the fuel rail from at least one of the plurality of pumping elements during the second time after measuring the pressure of the fuel rail during the second time.

10. The process of claim 1, wherein measuring the pressure of the fuel rail during the engine cycle includes making at least one pressure measurement of the fuel rail.

11. A system including an internal combustion engine, the system comprising:
a fuel injector in fluid communication with a fuel rail, the fuel injector operable to provide fuel to a cylinder of the internal combustion engine during an engine cycle;
a high pressure pump in fluid communication with the fuel rail, the high pressure pump including a plurality of pumping elements and a plurality of discrete quantity inlet metering valves associated with respective ones of the plurality of pumping elements; and
an electronic control system configured to:
control each of the plurality of discrete quantity inlet metering valves to terminate a fuel flow from the plurality of pumping elements to the fuel rail during the engine cycle;
measure a pressure of the fuel rail while the fuel flow from the plurality of pumping elements is terminated during the engine cycle; and
controlling the plurality of discrete quantity inlet metering valves to provide fuel flow from at least one of the pumping elements to pressurize the fuel rail during the engine cycle after measuring the pressure of the fuel rail.

12. The system of claim 11, wherein each of the plurality of discrete quantity inlet metering valves includes a valve seat, a plunger positionable to engage and disengage the valve seat, and a solenoid operable to actuate the plunger to engage or disengage the valve seat for fuel to flow to the fuel rail.

13. The system of claim 12, wherein each of the plurality discrete quantity inlet metering valves further includes a check valve downstream of the valve seat.

14. The system of claim 11, wherein:
the plurality of pumping elements includes a first pumping element and a second pumping element, and each of the first pumping element and the second pumping element includes chamber and a piston housed in the chamber to pump fuel from the chamber to the fuel rail; and
the plurality of discrete quantity inlet metering valves includes a first discrete quantity inlet metering valve upstream of the first pumping element and a second discrete quantity inlet metering valve upstream of the second pumping element.

15. The system of claim 11, wherein the electronic control system is configured to:
control each of the plurality of discrete quantity inlet metering valves to terminate the fuel flow at a predetermined camshaft angle of a camshaft that drives a pumping element of the corresponding discrete quantity inlet metering valve during the engine cycle.

16. The system of claim 11, wherein the electronic control system is configured to:
measure the pressure of the fuel rail immediately after each of the plurality of discrete quantity inlet metering valves is controlled to terminate the fuel flow and without purging the pumping elements.

17. The system of claim 11, wherein the electronic control system is configured to:
control each of the plurality of discrete quantity inlet metering valves a second time to terminate the fuel flow from the pumping elements to the fuel rail during the engine cycle;
measure the pressure of the fuel rail while the fuel flow to the fuel rail from the plurality of pumping elements is terminated during the second time; and
control the plurality of discrete quantity inlet metering valves to provide fuel flow to the fuel rail from at least one of the plurality of pumping elements during the second time after measuring the pressure of the fuel rail during the second time.

18. The system of claim 11, wherein the electronic control system is configured to:
inject fuel from the fuel injector during the engine cycle while the pressure of the fuel rail is measured.

19. The system of claim 11, wherein the fuel injector includes a plurality of fuel injectors in fluid communication with the fuel rail, and the electronic control system is configured to inject fuel from at least two of the fuel injectors during the engine cycles in which the pressure of the fuel rail is measured.

20. A method, comprising:
cutting out at least one fuel pump event associated with at least one injection event during each engine cycle of a plurality of engine cycles; and
measuring a fuel pressure while the fuel pump event is cut-out.
